(19) United States
(12) Patent Application Publication
(10) Pub. No.: US 2019/0291683 A1
(43) Pub. Date: Sep. 26, 2019

(54) GAS GENERATOR FOR A GAS BAG MODULE OF A VEHICLE OCCUPANT RESTRAINT SYSTEM AND METHOD FOR PRODUCING A GAS GENERATOR

(71) Applicant: Joyson Safety Systems Germany GmbH, Aschaffenburg (DE)

(72) Inventors: Michael STELLWAGEN, Aschaffenburg (DE); Rüdiger BEHRE, Rödermark (DE); Tobias FECHNER, Aschafffenburg (DE)

(73) Assignee: Joyson Safety Systems Germany GmbH, Aschaffenburg (DE)

(21) Appl. No.: 16/317,714

(22) PCT Filed: Jul. 17, 2017
(86) PCT No.: PCT/EP2017/068016

§ 371 Date: Jan. 14, 2019

(30) Foreign Application Priority Data
Jul. 15, 2016 (DE) 10 2016 213 002.1

(51) Int. Cl. B60R 21/264

(52) U.S. Cl. CPC B60R 21/2644; B60R 2021/26029

(57) ABSTRACT

It is provided a gas generator for a gas bag module of a vehicle occupant restraint system, comprising at least one chamber in which gas-generating material is arranged; a volume compensation arrangement which includes a first functional region for compensating at least a part of the volume of the chamber not occupied by the gas-generating material and a second functional region for exerting a restoring force on a component of the gas generator. The volume compensation arrangement comprises at least two compressible elements resting against each other, wherein at least one of the compressible elements in a first partial section that is associated with the first functional region of the volume compensation arrangement has another thickness than in a second partial section that is associated with the second functional region of the volume compensation arrangement.

### CROSS-REFERENCE TO A RELATED APPLICATION

This application is a National Phase Patent Application of International Patent Application Number PCT/EP2017/068016, filed on Jul. 17, 2017, which claims priority of German Patent Application Number 10 2016 213 002.1, filed on Jul. 15, 2016.

### BACKGROUND

This disclosure relates to a gas generator for a gas bag module of a vehicle occupant restraint system and to a method for producing a gas generator.

Such gas generators for inflating a gas bag include gas-generating material (in particular pyrotechnical material) for example in the form of tablets, wafers and/or a granular material.

The gas-generating material is arranged in a chamber (charge container), wherein filling fluctuations are compensated and the freedom of movement of the gas charge is limited in order to counteract a damage (for example due to abrasion) of the gas-generating material and/or a generation of noise. For this purpose, compressible volume compensation elements, for example ceramic cushions (such as “Superwool” cushions) are used.

For example, U.S. Pat. No. 9,073,512 B1 describes a gas generator with such a volume compensation element. It is desirable that beside a functional region for compensating a volume not occupied by the gas-generating material a volume compensation element provides at least one more functional region which for example exerts another (e.g. a lower) restoring force on another component of the gas generator. Designing the known volume compensation elements with different functional regions, however, is expensive.

### SUMMARY

The object underlying the proposed solution therefore consists in providing a gas generator with a volume compensation arrangement to be produced as easily as possible and equipped with a plurality of functional regions, and in indicating a corresponding method for producing a gas generator.

This object is solved by the provision of a gas generator with features as described herein and a method for producing a gas generator with features as described herein.

Accordingly, there is provided a gas generator for a gas bag module of a vehicle occupant restraint system, comprising
at least one chamber in which gas-generating material is arranged;
a volume compensation arrangement which includes a first functional region for compensating at least a part of the volume of the chamber not occupied by the gas-generating material and a second functional region for exerting a restoring force on a component of the gas generator (different from the gas-generating material), wherein
the volume compensation arrangement comprises at least two (elastically) compressible elements resting against each other, wherein at least one of the compressible elements in a first partial section that is associated with the first functional region of the volume compensation arrangement has another thickness than in a second partial section that is associated with the second functional region of the volume compensation arrangement.

Accordingly, at least one of the compressible elements includes partial sections with different thicknesses so that correspondingly the volume compensation arrangement (in particular formed only by the compressible elements) also has regions with different thicknesses. The two functional regions of the volume compensation arrangement in particular are associated with regions of the gas generator that have differently large void volumes, wherein due to their different thicknesses they produce different restoring forces. The “thickness” relates to the expansion perpendicularly to the main plane of extension of the elements.

The compressible elements for example each extend both in the first and in the second functional region. It is conceivable here that in a direction perpendicular to a longitudinal axis or an axis of rotation (such as the axis of symmetry of a pot-shaped gas generator) the functional regions of the gas generator are disposed one beside the other.

For example, the one of the compressible elements has a smaller thickness in its second partial section than in the first partial section so that the second functional region of the volume compensation arrangement has a smaller thickness than the first functional region (at least a smaller effective thickness responsible for the restoring force). Correspondingly, the restoring force exerted on the component of the gas generator is lower than the restoring force acting on the gas-generating material.

The use of two initially separate compressible elements thus simplifies the production of the different functional regions of the volume compensation arrangement and increases the creative freedom. For example, the compressible elements are plate-shaped elements, i.e. elements that in a starting condition each have an at least substantially constant thickness. The smaller thickness of the second partial section of the first one of the compressible elements then is formed e.g. by at least one continuous cutout (i.e. a through opening) in this region, i.e. has a thickness of zero in this region, while for instance the first partial section remains unchanged. The at least one cutout can be produced e.g. by punching or cutting; i.e. by 2D machining. Thus, a compressible element with partial sections of different thickness also is understood to be an element that is cut from a material plate of constant thickness and is provided with at least one continuous cutout (e.g. a punchout).

It is possible that the second compressible element has no cutouts in its partial sections associated with the first and second functional regions. Correspondingly, in this exemplary embodiment the volume compensation arrangement produced by combining the two compressible elements in at least one part of the second functional region has a thickness that corresponds to the thickness of the first compressible element, while in the first functional region the thicknesses of the two compressible elements add up. The different thicknesses of the functional regions of the volume compensation arrangement hence can be produced by comparatively easily producible continuous cutouts in at least one of the compressible elements. The removal of material only to a certain material depth, which is required therefor in a one-part volume compensation element, is omitted.

It is also possible that at least the one compressible element comprises a plurality of cutouts that form its partial section of reduced thickness. For example, two cutouts are present which are separated from each other by a (for example web-shaped) stabilizing portion. The stabilizing portion in particular allows a better handling of the compressible element before and/or during the assembly. According to a development, the other compressible element includes a corresponding cutout (in particular formed slightly larger than the stabilizing portion) into which the stabilizing portion at least partly extends during the assembly of the volume compensation arrangement, i.e. when arranging the two compressible elements at each other.

According to another exemplary embodiment the two compressible elements each include a through opening, which after the formation of the volume compensation arrangement, i.e. in a condition in which the two compressible elements rest against each other, are aligned with each other. A component of the gas generator different from the gas-generating material of the gas generator extends through the through openings aligned with each other.

For example, this component of the gas generator is an inner housing (which is arranged within an outer housing) in which an igniter of the gas generator is disposed. For example, the inner housing extends up to an inside of an outer housing of the gas generator in order to produce a thermal contact with the outer housing as good as possible. This serves to promote automatic triggering under the influence of external heat (“auto-ignition function”).

The second functional region of the volume compensation arrangement for example serves to exert a restoring force on a closure of an inner housing (which for example is a further inner housing) of the gas generator. For example, an igniter also is disposed in this inner housing.

It is conceivable in particular that one of the igniters mentioned above (the one disposed in the inner housing that extends through the through openings of the compressible elements) belongs to a first ignition stage and the other one of the igniters mentioned (the one disposed in the inner housing including a closure on which the second functional region of the volume compensation arrangement exerts a restoring force) belongs to a second ignition stage of the gas generator. On activation of the gas generator at least one of the two ignition stages is ignited, wherein an ignition also of the second ignition stage is effected when necessary (for example in dependence on the severity and/or kind of the accident).

It is conceivable that the compressible elements each are produced from a material plate of an elastically compressible material (e.g. of the above-mentioned ceramic wool, a plastic material, a wire mesh and/or rubber).

It is also possible that the two compressible elements are pressed onto each other; e.g. due to their mounting position in the gas generator. In particular components of the gas generator exert a contact pressure on the compressible elements after the assembly of the gas generator. It is possible that the above-mentioned stabilizing portion shears off due to the compressible elements being pressed onto each other when moving into the corresponding cutout of the other compressible element. However, this does not impair the function of the volume compensation arrangement, and the stabilizing portion rather serves to stabilize the compressible element before or during the assembly.

It is also conceivable that the compressible elements are cohesively, positively and/or frictionally connected to each other. For example, the compressible elements are glued to each other and/or connected to each other via pin- or clamp-like fastening elements (e.g. by stapling).

The disclosure also relates to a method for producing a gas generator, in particular a gas generator as described above, the method including the following steps:
filling of a chamber with a gas-generating material;
providing two compressible elements, wherein at least one of the compressible elements includes at least two partial sections with different thicknesses; and
arranging the compressible elements in a housing in contact with each other such that they form a volume compensation arrangement that includes a first functional region for compensating at least a part of the volume of the chamber not occupied by the gas-generating material and a second functional region for exerting a restoring force on a component of the gas generator.

The developments explained above with respect to the gas generator as described herein can of course analogously be used in the method as described herein.

### BRIEF DESCRIPTION OF THE DRAWINGS

The embodiments will be explained in detail below by means of several examples with reference to the Figures.

FIG. 1 shows a sectional view of a gas generator according to an exemplary embodiment.

FIG. 2 shows a sectional view of a volume compensation arrangement of the gas generator of FIG. 1.

FIG. 3A shows a first compressible element of the volume compensation arrangement of FIG. 2.

FIG. 3B shows a second compressible element of the volume compensation arrangement of FIG. 2.

FIG. 4A shows a section through the compressible element of FIG. 3A.

FIG. 4B shows a section through the compressible element of FIG. 3B.

FIG. 5A shows a view of an underside of the volume compensation arrangement formed of the compressible elements of FIGS. 3A and 3B.

FIG. 5B shows an upper side of the volume compensation arrangement.

### DETAILED DESCRIPTION

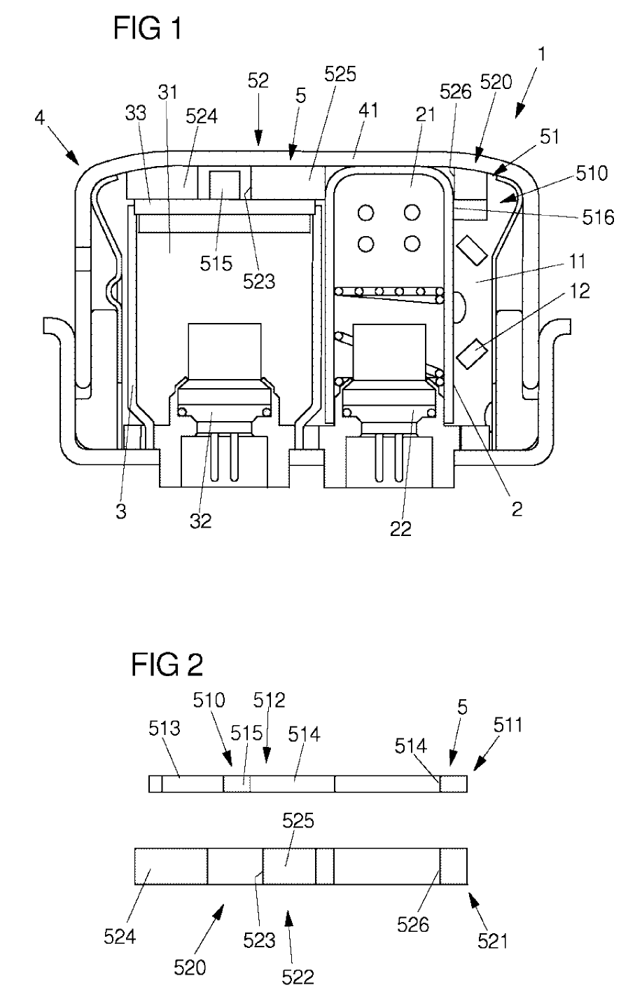

The (cylindrical, in particular disk-shaped) gas generator 1 as shown in FIG. 1 comprises a chamber 11 in which gas-generating material in the form of a pyrotechnical material 12 is arranged. Upon activation of the gas generator 1 the pyrotechnical material 12 releases gas for inflating a gas bag (not shown) of a gas bag module. In addition, the gas generator 1 comprises a first combustion chamber 21 enclosed by a first inner housing 2, in which a first igniter 22 of a first stage of the gas generator 1 is disposed. Furthermore, the gas generator 1 comprises a second combustion chamber 31 enclosed by a further inner housing 3, in which a second igniter 32 of a second stage of the gas generator 1 is disposed. The chamber 11 and the two combustion chambers 21, 31 are enclosed by an outer housing 4.

To avoid that after filling with the pyrotechnical material 12 too large an unfilled volume is obtained in the chamber 11, the gas generator 1 includes a volume compensation arrangement 5. The volume compensation arrangement 5 comprises a first functional region 51 which after filling in the pyrotechnical material 12 at least partly defines the chamber 11 and at least partly occupies a volume of the chamber 11 not filled by the pyrotechnical material 12. Thus, the first functional region 12 counteracts a movement and hence a generation of noise and/or an abrasion of the pyrotechnical material 12.

The volume compensation arrangement 5 also includes a second functional region 52 that is disposed between the second combustion chamber 31 and an inside of the outer housing 4. More exactly, an underside of the second functional region 52 rests against a closure lid 33 that releasably closes the combustion chamber 31 and exerts a restoring force on the closure lid 33. On activation of the igniter 32 the closure lid 33 will open against the restoring force of the second functional region 52 so that gases can leave the combustion chamber 31.

The restoring force of the second functional region 52 is produced in that during the assembly the volume compensation arrangement 5 is compressed between the outer housing and the closure lid 33 in its second functional region 52. The magnitude of this restoring force is determined in particular by the thickness of the volume compensation arrangement 5 in the second functional region 52. In particular, the volume compensation arrangement 5 has a smaller thickness there than in the first functional region 51, as the required restoring force for securing the closure lid 33 and the free volume available above the combustion chamber 31 is smaller than the restoring force to be exerted on the pyrotechnical material 12 in the chamber 11 or the free volume to be compensated there.

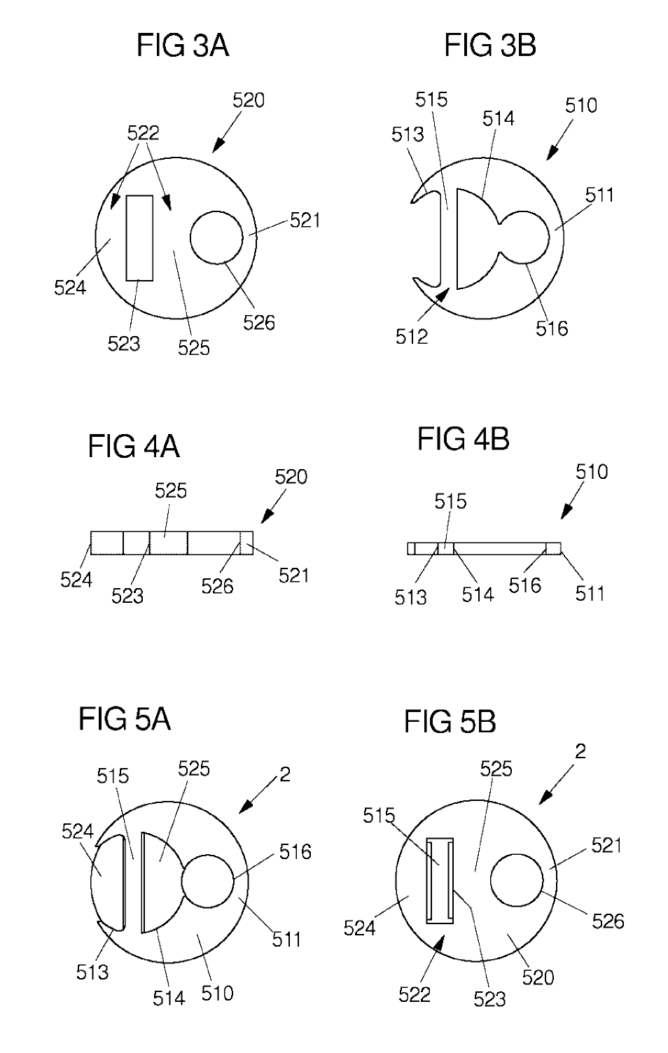

The volume compensation arrangement 5 comprises a first compressible element in the form of a first compressible cushion 510 and a second compressible element in the form of a second compressible cushion 520. The cushions 510, 520 are of plate-like design and each have a circular contour formed corresponding to the shape of the outer housing 4; cf. the top views of the cushions 510, 520 shown in FIGS. 3A, 3B.

The first cushion 510 has a first partial section 511 that is associated with the first functional region 51 of the volume compensation arrangement 5 and a second partial section 512 that is associated with the second functional region 52. The first partial section 511 has a thickness that corresponds to the original material plate from which the first cushion 510 has been made. In the second partial section 512 two cutouts 513, 514 separated from each other by a web 515 are disposed. Outside the web 515 the second partial section 512 thus has a reduced thickness as compared to the first partial section 511 (namely the thickness zero). The web 515 merely serves for the stabilization and hence for the better handleability of the first cushion 510. It is also conceivable that the web 515 is omitted and a single cutout instead of the separate cutouts 513, 514 is provided.

The second cushion 520 likewise has a first partial section 521 associated with the first functional region 51 of the volume compensation arrangement 5 and a second partial section 522 associated with the second functional region 52 of the volume compensation arrangement 5. In the second partial section 522 a cutout 523 is disposed which is formed and arranged corresponding to the web 515 of the first cushion 510. Adjacent to the cutout 523 the second partial section 522 has two regions 524, 525 without a cutout (i.e. with a thickness not reduced as compared to the material plate used for producing the second cushion 520), which after arranging the cushions 510, 520 at each other are accessible through the cutouts 513, 514. In the gas generator 1 the regions 524, 525 of the second cushion 520 therefore rest against the closure lid 33 of the first combustion chamber 31 through the cutouts 513, 514 and exert the above-mentioned restoring force on the closure lid 33. Hence, in particular material plates of different thickness are used for producing the cushions 510, 520. It is conceivable that standard material plates of specified thickness, e.g. about 6 mm (in particular 6.4 mm) or about 3 mm (in particular 3.2 mm) are used.

For producing the volume compensation arrangement 5 the two cushions 510, 520 are arranged at each other such that they each rest against each other via their large end faces at least substantially congruently. For example, the cushions 510, 520 are pressed onto each other, wherein the web 515 is fitted into the slightly larger cutout 523. Arranging the cushions 510, 520 at each other can be effected already before arranging the same in the outer housing 4 of the gas generator 1. It is also conceivable that the cushions 510, 520 are pressed onto each other only during the assembly of the gas generator 1, in particular by the attachment of an upper part 41 of the outer housing 4. The two cushions 510, 520 are arranged to rest against each other such that their first partial sections 511, 521 lie one above the other and form the first functional region 51, wherein the thicknesses of the partial sections 511, 521 add up.

Furthermore, the cutouts 513, 514 of the first cushion 510 lie above (or below) the regions 524, 525 of the second partial section 522 of the second cushion 520 so that the effective thickness of the volume compensation arrangement 5 in its second functional region 52 corresponds to the thickness of the regions 524, 525 (i.e. the thickness of the material plate used for producing the second cushion 520). When pressing the cushions 510, 520 onto each other, it is possible in particular that the regions 524, 525 at least partly move into the cutouts 513, 514. Thus, the structure of the volume compensation arrangement 5 shown in FIG. 1 is obtained; in particular the smaller thickness of its second functional region 52 as compared to the thickness of the first functional region 51. It is conceivable in addition that the cushions 510, 520 have structures that provide for a positive and/or non-positive connection of the cushions to each other. It is also possible that the cushions 510, 520 are cohesively connected to each other, in particular glued to each other.

In addition, the cushions 510, 520 each include a further cutout 516, 526 which after the assembly, i.e. in the finished volume compensation arrangement 5, are aligned with each other and form a third functional region of the volume compensation arrangement 5. An upper portion of the first inner housing 2 extends through the cutouts 516, 526 so that it comes to rest against an inside of the upper part 41 of the outer housing 4. This is to create a thermal contact between the first inner housing 2 and the surroundings of the gas generator as good as possible (for realizing an auto-activation function of the gas generator as already explained above).

The cushions 510, 520 are shown in a top view in FIGS. 3A (cushion 520) and 3B (cushion 510) and in a sectional view in FIGS. 4A and 4B. A top view (view from below, i.e. seen from an underside with the igniters 22, 32 of the gas generator 1) of the volume compensation arrangement 5 is shown in FIG. 5A. The upper side of the volume compensation arrangement 5 is shown in FIG. 5B.

It should be noted that the volume compensation arrangement 5 can of course also include more than the illustrated three functional regions, wherein additional functional regions serve e.g. for generating a restoring force on further components of the gas generator 1. In addition, the cutouts 516, 526 aligned with each other for accommodating the first inner housing 2 are not absolutely necessary, i.e. there can very well be merely two functional regions. The construction of the gas generator 1 as shown in FIG. 1 also is merely exemplary. The solution can also be realized with differently designed gas generators; for example with single-stage gas generators or with gas generators that have an oblong or no rotationally symmetrical shape.

1. A gas generator for a gas bag module of a vehicle occupant restraint system, comprising
at least one chamber in which gas-generating material is arranged;
a volume compensation arrangement which includes a first functional region for compensating at least a part of the volume of the chamber not occupied by the gas-generating material and a second functional region for exerting a restoring force on a component of the gas generator,
wherein the volume compensation arrangement comprises at least two compressible elements resting against each other, wherein at least one of the compressible elements in a first partial section that is associated with the first functional region of the volume compensation arrangement has another thickness than in a second partial section that is associated with the second functional region of the volume compensation arrangement.

2. The gas generator according to claim 1, wherein the compressible elements each extend both in the first and in the second functional region.

3. The gas generator according to claim 1, wherein the compressible elements are plate-like elements that rest against each other via one of their side faces.

4. The gas generator according to claim 1, wherein in its second partial section the compressible element has a smaller thickness than in the first partial section.

5. The gas generator according to claim 4, wherein the smaller thickness is formed by at least one cutout in the compressible element.

6. The gas generator according to claim 5, wherein the compressible element includes two cutouts that are separated from each other by a stabilizing portion.

7. The gas generator according to claim 5, wherein the other compressible element includes a cutout into which the stabilizing portion at least partly extends.

8. The gas generator according to claim 1, wherein the compressible elements each include at least one through opening and are arranged relative to each other such that the through openings are aligned with each other, wherein a component of the gas generator different from the gas-generating material extends through the through openings.

9. The gas generator according to claim 8, wherein the component of the gas generator is an inner housing in which an igniter is arranged.

10. The gas generator according to claim 1, wherein the second functional region of the volume compensation arrangement exerts a restoring force on a component in the form of a closure of an inner housing of the gas generator.

11. The gas generator according to claim 10, wherein an igniter is disposed in the inner housing.

12. The gas generator according to claim 1, wherein the component of the gas generator is an inner housing in which an igniter, which belongs to a first ignition stage of the gas generator, is arranged and wherein the second functional region of the volume compensation arrangement exerts a restoring force on a component in the form of a closure of an inner housing of the gas generator, wherein an igniter is disposed in the inner housing which belongs to a second ignition stage of the gas generator.

13. The gas generator according to claim 1, wherein the compressible elements are pressed onto each other.

14. The gas generator according to claim 1, wherein the compressible elements are cohesively, positively and/or frictionally connected to each other.

15. The gas generator according to claim 1, wherein the compressible elements are formed of an elastic material.

16. A method for producing a gas generator, comprising the steps:
filling a chamber with a gas-generating material;
providing two compressible elements, wherein at least one of the compressible elements includes at least two partial sections with different thicknesses; and
arranging the compressible elements in a housing in contact with each other such that they form a volume compensation arrangement that includes a first functional region for compensating at least a part of the volume of the chamber not occupied by the gas-generating material and a second functional region for exerting a restoring force on a component of the gas generator.
